(19) United States
(12) Patent Application Publication
(10) Pub. No.: US 2006/0236108 A1
(43) Pub. Date: Oct. 19, 2006

(54) Instant process termination tool to recover control of an information handling system

(76) Inventor: Carlton A. Andrews, Austin, TX (US)

Correspondence Address: HAMILTON & TERRILE, LLP, P.O. BOX 203518, AUSTIN, TX, 78720, US

(21) Appl. No.: 11/046,147

(22) Filed: Jan. 28, 2005

(51) Int. Cl. H04L 9/00

(52) U.S. Cl. 713/170

(57) ABSTRACT

A method and system for automatic termination of unauthorized malevolent processes operating on an information handling system. A list of authenticated and essential process list is stored on the information handling system. Unauthorized processes not contained on the list can be automatically terminated by the user by invoking the present invention with a single click of a mouse or pointer device on an icon residing on the display screen of the information handling system. The offending processes are immediately terminated without generating a user prompt, which would ordinarily provide sufficient time for the malware to spawn additional offending processes. The present invention also provides significant means to recover control of a malware-infected information handling system in order to use repair tools and utilities. The present invention can be deployed at the time of manufacture of an information handling system or independently installed by a user.

### BACKGROUND OF THE INVENTION

1. Field of the Invention

The present invention relates in general to the field of information handling systems management and deployment, and more specifically, to recovering control of a malfunctioning system by automatically terminating malevolent processes operating thereon.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

The ubiquitous availability of Internet access and its widespread use by consumers has given rise to a growing number of information handling systems being infected by a group of malicious software programs commonly referred to as “malware.” This generalized term for malevolent computer code encompasses adware, spyware, viruses, worms, and Trojan-horses. Any of these can compromise an information handling system and they can propagate by multiple methods, injecting malicious code into the executable files on a system, or adding script code into HTML files.

Each form of malware has specific characteristics, which must be understood before effective countermeasures to infection can be applied. Adware are malevolent programs that facilitate delivery of advertising content to an information handling system. The presence of adware on a system is usually apparent, as the number and frequency of ads increases dramatically. A user may unknowingly receive and/or trigger adware by innocently downloading content from Web sites, receiving email messages, or interacting with instant messenger applications. Spyware are an associated class of malware programs, which have the ability to scan information handling systems or monitor Internet activity or other computing habits, and relay this information to other computers or locations in cyber-space. Unlike adware, whose presence is noticeable, spyware usually attempts to make its presence on a system unknown to the user.

A virus is code that replicates itself onto files with which it comes in contact. A virus can infect another program, boot sector, partition sector, or a document that supports macros, by inserting or attaching itself to that medium. A worm is a program that makes and then distributes copies of itself. Infection of an information handling system by a worm often occurs when a user clicks on an infected e-mail or downloads what appears to be legitimate content from a web site. A worm can propagate itself by using system software to copy itself from one disk drive to another, by invoking email capabilities, or through many other network transport mechanisms.

A Trojan horse portrays itself as something other than what it is at the point of execution. While it may advertise its activity after launching, its presence may not be apparent to the user beforehand. A Trojan horse neither replicates nor copies itself and must either arrive in the form of a program, or be carried by another program. Trojans are often designed for a specific purpose, such as relaying spam messages.

While all malware causes problems, adware and spyware are particularly disruptive, and an information handling system that is heavily infested with such programs may become almost unusable from time of boot. Many information handling systems are not equipped with appropriate adware/spyware tools, requiring their acquisition and installation before remedial efforts can begin. Even if such tools are present, pop-ups and screen animations can be so rampant as to overwhelm the host CPU and graphics processor, rendering such remedies useless.

Additionally, adware programs spawn or trigger additional pop-ads, often referred to as “exploding screens” as soon as attempts are made to terminate the first pop-up ad. Often, it is impossible for the user to react quickly enough to terminate one newly-spawned pop-up ad before others are spawned in quick succession. This phenomena, coupled with slow system response, severely handicaps problem resolution by a technician providing remote support to an information handling system user by telephone. In many cases, even an accomplished technician who is physically present has difficulty terminating pop-up ads fast enough to install or invoke diagnostic and/or repair tools for corrective action.

Many current malevolent process removal applications run a scan of processes, registry key, and files against a predetermined list of malicious programs. If a match is found, the user is prompted for permission to automatically eliminate the malevolent processes or programs, or the user is prompted to eliminate them through manual interaction. Some of these malevolent process removal tools presume foreknowledge of specific offensive processes or programs and their associated characteristics, or “signature.” Other malevolent process removal tools require constant updates in order to identify new malware.

Generally, the individual characteristics of each information handling system platform demand different approaches to this problem. For instance, in the Windows operating system (OS), invoking the Windows Task Manager is the most effective way to regain control of the information handling system before adware/spyware processes or other malevolent programs take over. But even this approach is problematic, as the name of the offending process is often not obvious and foreknowledge is required about which system processes are essential for the system to continue operating. Further, there are many processes to choose from while deciding which ones to terminate. If the user hesitates, or takes too long to choose the right process to terminate, additional malevolent processes can be spawned. Similarly, the offending process may not terminate immediately, requiring the user to respond to cryptic system prompts, likewise causing user hesitation and allowing time for additional malware processes to spawn.

An effective system and method for the automated termination of malevolent processes and/or programs while in active operation does not exist today. The lack of such a system and method poses significant challenges to recovering control of a malware-infected information handling system in order to use repair tools and utilities.

### SUMMARY OF THE INVENTION

The method and system of the present invention overcomes the shortcomings of prior art by automating the termination of a plurality of malevolent processes while in active operation, collectively referred to as malware, typified by adware, spyware, viruses, worms, and Trojan horses. The present invention also provides significant means to recover control of a malware-infected information handling system in order to use repair tools and utilities. Further, the present invention can be deployed at the time of manufacture of an information handling system or independently installed by a user. After deployment or installation, the essential process list can be updated whenever new software is loaded onto the target information handling system and repair tools and utilities are used to verify that the system continues to remain uninfected. If the system is uninfected, the essential process list is updated and used thereafter.

In an embodiment of the invention, the method and system of the present invention uses a scanning application that produces an authenticated and essential process list by identifying all existing processes and their file launch locations on an uninfected information handling system. Once produced, or updated after subsequent infection-free software installations, the authenticated and essential process list is stored on the information handling system. In the event of a malware attack, the present invention can be invoked and all currently running processes identified.

In one embodiment of the invention, all unknown processes, or any process not previously registered on the authenticated and essential process list can be automatically terminated by the user by invoking the present invention with a single click of a mouse or pointer device on an icon residing on the display screen of the information handling system. The offending processes are immediately terminated without generating a user prompt, which would ordinarily provide sufficient time for the malware to spawn additional offending processes. This includes processes with the same name as an authenticated and essential process, but initiated from a non-authentic file launch location. In another embodiment of the invention, all known web browser processes are terminated with a single click by clearing the machine state when hostile web pages begin spawning multiple windows. Termination of such malevolent processes recovers the information handling system to a state where repair tools and utilities can be used.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a schematic diagram of a software installation system at an information handling system manufacturing site.

FIG. 2 is a generalized illustration of an information handling system, such as the target information handling system 180 illustrated in FIG. 1.

FIG. 3 is a flowchart illustration of the process sequence for implementation of the method and system of the invention.

### DETAILED DESCRIPTION

Although the present invention has been described in detail, it should be understood that various changes, substitutions and alterations can be made hereto without departing from the spirit and scope of the invention as defined by the appended claims.

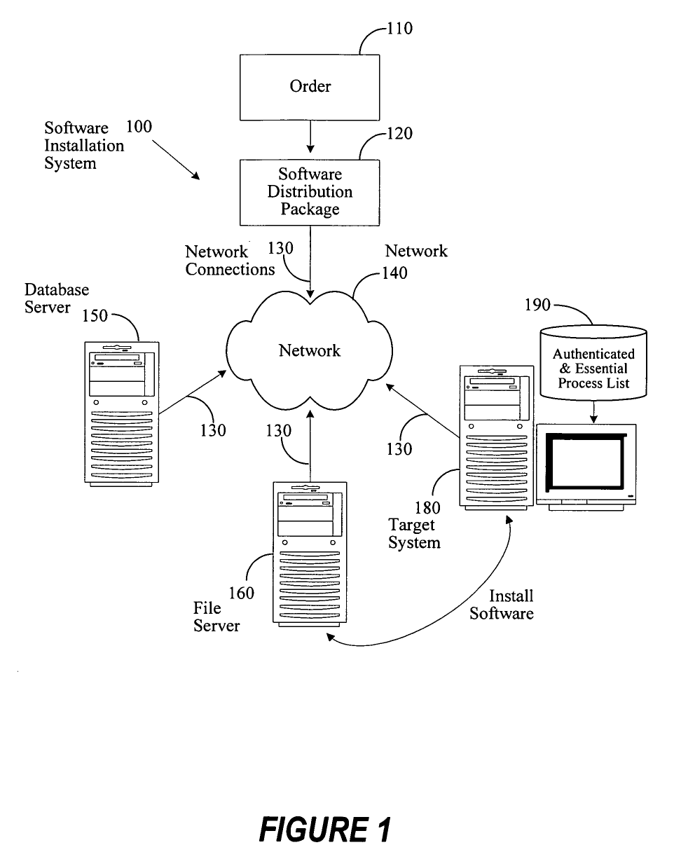

FIG. 1 is a schematic diagram of a software installation system 100 at an information handling system manufacturing site. In operation, an order 110 is placed to purchase a target information handling system 180. The target information handling system 180 to be manufactured contains a plurality of hardware and software components. For instance, target information handling system 180 might include a certain brand of hard drive, a particular type of monitor, a certain brand of processor and software. The software may include a particular version of an operating system along with all appropriate driver software and other application software along with appropriate software bug fixes. Before the target information handling system 180 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 180. A software distribution package 180 is provided by converting an order 110.

Having read the plurality of software distribution packages 120, database server 150 provides a plurality of software components corresponding to the software components residing in one or more file servers 160 over network connection 130. Network connection 130 may be to any network 140 well-known in the art, such as a local area network, an intranet, or the Internet. The information contained in database server 150 is often updated such that the database contains a new factory build environment. The software is then installed on the target information handling system 180. Upon completion, the information handling system 180 will have a predetermined set of software, including a predetermined set of drivers corresponding to the specific configuration of the information handling system 180. Once the software components are installed and validated on the target system 180, the present invention constructs an authenticated and essential process list 190.

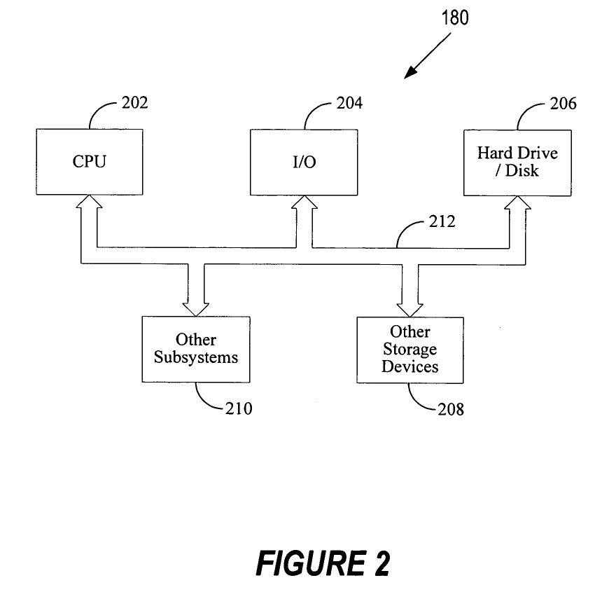

FIG. 2 is a generalized illustration of an information handling system, such as the target information handling system 180 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. In various embodiments of the present invention, a plurality of executable files and a list of authorized files and processes can be stored on the hard drive 206 and other storage devices 208. Alternatively, the software executable files and other files can be installed onto any appropriate non-volatile memory. The non-volatile memory may also store the information relating to which factory build environment was used to install the software. As will be understood by those of skill in the art, execution by the processor of the executable files stored on the hard drive 206 or other storage devices 208 results in activation of various processes for processing and displaying data. In addition to the processes initiated by execution of files in the various storage media, a plurality of processes can be initiated by various instances of an internet browser that is used to manage data transfer between the information handling system and the internet.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example, an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

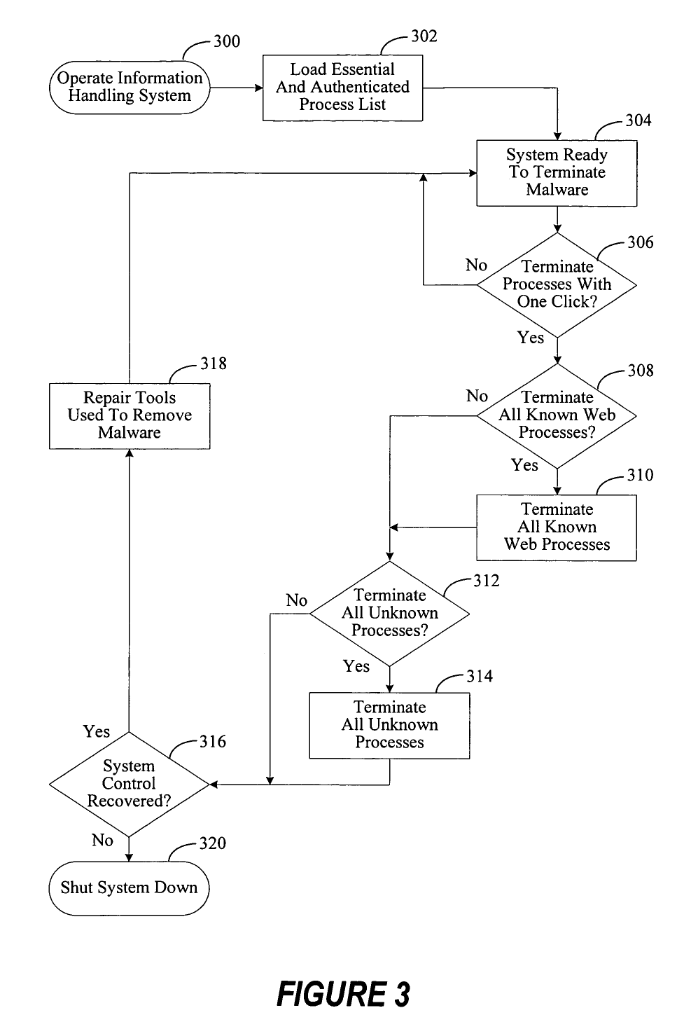

FIG. 3 is a flowchart illustration of the process sequence for implementation of the method and system of the invention. In step 300, the information handling system is placed in an operating state. In step 302, the essential and authenticated process list is loaded into the information handling system.

In step 304, the system is placed into a state of readiness to terminate malevolent processes. In step 306, the termination of malevolent processes can be initiated by invoking the present invention by a single click of a mouse or pointer device on an icon residing on the display screen of the information handling system.

If, in step 306, the termination of malevolent processes is not initiated by invoking the present invention, then in step 304, the system remains in a state of readiness to terminate malevolent processes.

If, in step 306, the termination of malevolent processes is initiated by invoking the present invention, then in step 308, the termination of all known web processes that are in current operation can be chosen. If chosen, then in step 310, all such identified processes are terminated by the present invention. In step 312, the termination of all unknown processes that are in current operation can be chosen. If chosen, then in step 314, all such identified processes are terminated by the present invention.

If, in step 316, control of the information handling system has been reclaimed and operation has been properly restored, then in step 318 repair tools and utilities can be used to eliminate malware on the information handling system. In step 304, the system is returned to a state of readiness to terminate malevolent processes.

If, in step 316, system control has not been reclaimed and/or operation has not been properly restored, the information handling system is shut down in step 320.

Use of the invention will insure, at a minimum, that malevolent processes in active operation within an information handling system can be automatically terminated with no user intervention. Furthermore, terminating these malevolent processes will assist in recovering control of a malfunctioning system in order to use repair tools and utilities.

What is claimed is:

1. An information handling system, comprising:
data storage;
a plurality of executable files in said data storage, said executable files being operable to generate a plurality of processes;
a list of authorized processes stored in said data storage; and
a processor operable to execute said plurality of executable files and to control operation of processes generated therefrom;
wherein said processor is operable to terminate selected processes not contained in said list of authorized processes.

2. The system of claim 1, wherein said list of authorized processes comprises information relating to the file name and the launch location of the corresponding process.

3. The system of claim 2, wherein said list of authorized processes is installed on said information handling system during a factory installation process.

4. The system of claim 2, wherein said list of authorized processes is generated by a user of said information handling system.

5. The system of claim 4, wherein said list of authorized processes is obtained by identifying all processes running on said information system at a predetermined point in time wherein said information processing system is not infected with unauthorized processes.

6. The system of claim 5, wherein said unauthorized processes comprise processes generated by an internet browser.

7. The system of claim 6, wherein said processor terminates processes corresponding to known instances of said internet browser.

8. The system of claim 7, wherein said processes corresponding to known instances of said internet browser are terminated by clearing the machine state of said processor upon detection of multiple graphical user interface windows being generated by said processes corresponding to said known instances of said internet browser.

9. The system of claim 6, wherein said processor terminates processes corresponding to known internet files and all processes not contained on said list of authorized processes.

10. The system of claim 9, wherein said processes corresponding to known internet files are terminated by clearing the machine state of said processor upon detection of multiple graphical user interface windows being generated by said internet files.

11. A method of operating an information handling system, comprising:
storing a plurality of executable files in data storage in said information handling system, said executable files being operable to generate a plurality of processes;
storing a list of authorized processes in data storage in said information handling system; and
using a processor to execute said plurality of executable files and to control operation of processes generated therefrom;
wherein said processor is operable to terminate selected processes not contained in said list of authorized processes.

12. The method of claim 11, wherein said list of authorized processes comprises information relating to the file name and the launch location of the corresponding process.

13. The method of claim 12, wherein said list of authorized processes is installed on said information handling system during a factory installation process.

14. The method of claim 12, wherein said list of authorized processes is generated by a user of said information handling system.

15. The method of claim 14, wherein said list of authorized processes is obtained by identifying all processes running on said information system at a predetermined point in time wherein said information processing system is not infected with unauthorized processes.

16. The system of claim 15, wherein said unauthorized processes comprise processes generated by an internet browser.

17. The system of claim 16, wherein said processor terminates processes corresponding to known instances of said internet browser.

18. The system of claim 17, wherein said processes corresponding to known instances of said internet browser are terminated by clearing the machine state of said processor upon detection of multiple graphical user interface windows being generated by said processes corresponding to said known instances of said internet browser.

19. The method of claim 16, wherein said processor terminates processes corresponding to known internet files and all processes not contained on said list of authorized processes.

20. The method of claim 19, wherein said processes corresponding to known internet files are terminated by clearing the machine state of said processor upon detection of multiple graphical user interface windows being generated by said internet files.
